(19) United States
(12) Patent Application Publication
(10) Pub. No.: US 2011/0266097 A1
(43) Pub. Date: Nov. 3, 2011

(54) ELEVATOR

(75) Inventors: Petteri VALJUS, Helsinki (FI); Raimo PELTO-HUIKKO, Vantaa (FI); Riku LAMPINEN, Helsinki (FI); Lasse HEIKKILÄ, Helsinki (FI)

(73) Assignee: KONE CORPORATION, HelsinkI (FI)

(21) Appl. No.: 13/183,229

(22) Filed: Jul. 14, 2011

Related U.S. Application Data
(63) Continuation of application No. PCT/FI2010/000004, filed on Jan. 15, 2010.
Application No. PCT/FI2010/000004 is a continuation of application No. 12/838,156, filed on Jul. 16, 2010.
Application No. 12/838,156 is a continuation of application No. PCT/FI2009/000018, filed on Jan. 15, 2009.

(30) Foreign Application Priority Data
Jan. 18, 2008 (FI) FI20080045
Sep. 25, 2008 (FI) FI20080538
Jul. 10, 2009 (FI) FI20090273

(51) Int. Cl. B66B 11/00; B66B 11/08; B66B 7/00

(52) U.S. Cl. 187/254

(57) ABSTRACT

Elevator, preferably a passenger elevator, which comprises an elevator car, and at least one hoisting rope for moving and supporting the elevator car, a traction sheave that acts on the hoisting rope, and a power source for rotating the traction sheave. The counterweight of the elevator comprises a brake for decelerating and/or preventing at least upward movement of the counterweight.

### FIELD OF THE INVENTION

The object of the invention is an elevator, preferably an elevator suited at least to passenger traffic.

### BACKGROUND OF THE INVENTION

The elevator car and the counterweight are most commonly moved in elevators via hoisting roping moved by a traction sheave. A traction sheave can be used to brake the movement speed of an elevator car in a situation in which the elevator car is moving downwards by directing a force pulling upwards from the traction sheave to the elevator car with the hoisting rope between the traction sheave and the elevator car. Instead, a counterweight moving upwards in this type of situation cannot be braked with the hoisting rope between the traction sheave and the counterweight, because a force pushing the counterweight downwards cannot be transmitted along the rope. The problem is conventionally solved with an arrangement in which the counterweight and the elevator car are connected with a compensating rope or corresponding that passes around a diverting pulley supported in its position at the bottom end of the elevator hoistway. The rope is thus able to transmit the force decelerating the elevator car also to the counterweight and exerts on the counterweight a force pulling it downwards by taking supporting force from the aforementioned diverting pulley. Thus it prevents continuation of the movement of the counterweight in a situation in which the elevator car stops suddenly. At the same time it prevents slackening of the hoisting roping between the counterweight and the traction sheave in the aforementioned situation. This type of continuation of movement must be prevented because when the movement finally stops from the effect of gravitation the counterweight would, enabled by the slackened ropes, be able to reverse the direction of its movement and to drop downwards to hang on the ropes, which dropping would cause a dangerous situation because the impulse caused by the dropping would be transmitted also to the elevator car via the hoisting roping. The solution in question also generally delivers a compensating function. This is necessary because when the hoisting ropes are very heavy with respect to the load of the elevator, they considerably affect the balance status of the elevator. The position of the elevator car and the counterweight in the elevator hoistway changes during a run and some elevator rope moves from the elevator car side of the traction sheave to the counterweight side. This imbalance is conventionally equalized because the mass per meter of the rope passing around the aforementioned diverting pulley is fitted to be such that the forces it exerts on the elevator car and on the counterweight cancel the aforementioned imbalance.

A problem in the aforementioned solutions is that they increase the moving parts of the elevator and make the solution complex and expensive. Likewise a diverting pulley must be arranged in the bottom space of the elevator, which increases the need for bottom space. At the same time the accelerating masses of the elevator also increase.

### OBJECT OF THE INVENTION

The object of the invention is to eliminate, among others, the aforementioned drawbacks of prior-art solutions. More particularly the purpose of the invention is to produce a simpler elevator than earlier ones.

The object of the invention is to achieve one or more of the following advantages, among others:
An elevator is achieved that is safe
An elevator is achieved that behaves safely in sudden stops.
An elevator is achieved that can be formed to be one without compensating rope.
An elevator is achieved, the hoisting ropes of which are so light that the elevator can be formed without compensating rope and which elevator is however safe in a jumping situation.
An elevator is achieved, in which the moving and accelerating masses as well as the shaft loads are smaller than before.
An elevator is achieved, the rope of which is light and of high tensile strength and tensile rigidity with respect to its dead weight.
An elevator is achieved, the tolerance to high temperatures of which is better than before.
An elevator is achieved, the rope of which possesses high thermal conductivity combined with good tolerance to high temperatures.
An elevator is achieved, the bottom clearance of which is more spacious.
An elevator is achieved, the roping of which is light.
An elevator is achieved in which there is not discontinuity and intermittency of the rope, owing to which the rope of the elevator is quiet and advantageous in terms of vibration.
An energy-economic elevator is achieved.
An elevator is achieved, wherein the deceleration of the car and/or counterweight can be increased with a brake during traction sheave braking.
An elevator is achieved, wherein it is easy to prevent movement of the car of which from a landing with the doors open with a brake.

### SUMMARY OF THE INVENTION

The elevator according to the invention can be said to be characterized by what is disclosed in the characterization part of claim 1. Other embodiments of the invention are characterized by what is disclosed in the other claims. Some inventive embodiments are also discussed in the descriptive section and in the drawings of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. The features of the various embodiments can be applied within the framework of the basic inventive concept in conjunction with other embodiments.

The elevator according to the invention, preferably a passenger elevator, comprises an elevator car, and at least one hoisting rope for moving and supporting the elevator car, a traction sheave that acts on the hoisting rope, and a power source for rotating the traction sheave. The counterweight of the elevator comprises a brake for decelerating and/or preventing at least upward movement of the counterweight. One advantage, among others, is that jumping of the counterweight can be prevented and the causing of an impulse to the elevator car subsequent to a jump can be prevented. The brake, on the other hand, enables slowing of the speed of the counterweight, which can be advantageous for other reasons, e.g. for enhancing traction sheave braking or for preventing subsidence of the car when it is at a landing with doors open.

In one embodiment of the invention the elevator is formed to be without compensating rope. Thus the overall roping of the elevator is light.

In one embodiment of the invention the hoisting rope/hoisting ropes, which is/are arranged to move the elevator car and counterweight, comprise only non-metallic load-bearing parts. Thus the hoisting rope/ropes are light. These types of materials are presented elsewhere in this application, most preferably composite material. Also, e.g. load-bearing parts based on Aramid fibers, e.g. Aramid braids, are suitable for this.

In one embodiment of the invention the elevator however comprises a trailing cable leading electricity and/or information to the car.

In one embodiment of the invention the elevator is formed to be without compensating rope, more particularly without a compensating rope that equalizes the loads led to the traction sheave from the rope masses from the compensating ropes and hoisting ropes coming to the traction sheave from its opposite sides such that they remain essentially the same irrespective of the position of the elevator car.

In one embodiment of the invention at least the counterweight, and preferably also the elevator car, comprises a brake, which corresponds to a guide rail, under the control of which the counterweight/elevator car in question travels.

In one embodiment of the invention the brake is a jump prevention means, i.e. to prevent the aforementioned counterweight and/or elevator car from jumping e.g. to prevent continuation of the free movement of the counterweight in a situation in which the speed of the elevator car is slowed down too quickly. In this way the elevator can even be formed to be without compensating rope. In this case the hoisting roping is preferably light, preferably of some type described in this application.

In one embodiment of the invention the brake comprised in the counterweight is arranged to brake in a situation in which the elevator car suddenly stops or at least slows its speed, and preferably in addition the brake comprised in the elevator car is arranged to brake in a situation in which the counterweight suddenly stops or at least slows its speed. In this way the elevator can even be formed to be without compensating rope.

In one embodiment of the invention the deceleration of the aforementioned elevator car or counterweight is 9.81 m/s2 or over in the aforementioned sudden stopping or slowing down, and the aforementioned brake is preferably arranged to activate only in a situation in which the aforementioned deceleration is 9.81 m/s2 or over.

In one embodiment of the invention the counterweight comprises means that are arranged to activate the aforementioned brake comprised in the counterweight if the deceleration of the elevator car exceeds a certain pre-defined limit value. This can be implemented e.g. by adjusting the spring force F to be suitable on the basis of the rope tension of the hoisting rope connected to the counterweight. Alternatively, the elevator can comprise for this purpose means for determining the acceleration of the elevator car and for activating the brake of the actuator on the basis of the acceleration. In this case an electronic solution of small size, and which does not require complex mechanics, can be used.

In one embodiment of the invention the elevator car comprises means that are arranged to activate the brake comprised in the elevator car if the deceleration of the counterweight exceeds a certain pre-defined limit value. This can be implemented e.g. by adjusting the spring force F to be suitable on the basis of the rope tension of the hoisting rope connected to the elevator car. Alternatively, the elevator can comprise for this purpose means for determining the acceleration of the counterweight and for activating the brake of the actuator on the basis of the acceleration. In this case an electronic solution of small size, and which does not require complex mechanics, can be used.

In one embodiment of the invention the braking power of the brake is dimensioned so that it does not cause deceleration greater than a certain pre-defined value, which value is between 3-5 m/s2, to an empty elevator car in any tripping situation of the brake. Thus the elevator is safe.

In one embodiment of the invention the braking of the brake comprised in the elevator car and/or of the brake (11) comprised in the counterweight is arranged to start as a consequence of reduced tension of the hoisting ropes, e.g. after the tension of the hoisting rope (R) has decreased to below a certain limit tension.

In one embodiment of the invention at least the brake comprised in the elevator car is a safety gear corresponding to a guide rail of the elevator car in question, preferably a safety gear that is connected also to the overspeed governor of the elevator, which overspeed governor activates the aforementioned safety gear after the movement speed of the elevator car has exceeded a certain pre-defined limit value.

In one embodiment of the invention the brake is such that after activating it stops the aforementioned elevator car or counterweight with an acceleration of over 2 m/s2, but with an acceleration of at the highest 9.81 m/s2.

In one embodiment of the invention the hoisting rope (alone or together with corresponding ropes) is arranged to move an elevator car and a counterweight, which are preferably suspended on opposite ends of the rope.

In one embodiment of the invention a compensating rope or corresponding is not connected to the counterweight and/or to the elevator car, which compensating rope or corresponding can pull it/them downwards with a force that depends on the vertical position of the elevator car/counterweight in question so that the magnitude of the force increases as the elevator car moves upwards and decreases as the elevator car moves downwards.

In one embodiment of the invention the brake is activated in a situation in which the movement speeds of the elevator car and the counterweight, which otherwise move at the same speed as each other, start to diverge from each other. The elevator comprises for this purpose means for determining the movement speeds of the elevator car and of the counterweight. When the basis for tripping is a divergence of movement speeds an electronic solution of small size, which does not require complex mechanics, can be used.

In one embodiment of the invention the counterweight and the elevator car are not connected with a rope or corresponding that passes around a diverting pulley at the bottom end of the elevator hoistway.

In one embodiment of the invention the aforementioned hoisting rope comprises at least one, preferably a plurality of load-bearing parts, which load-bearing part is of composite material, which composite material comprises reinforcing fibers, which are preferably carbon fiber or glass fiber, embedded into a polymer matrix. Thus a rope can be formed that is light, rigid, durable and simple to manufacture.

In one embodiment of the invention the aforementioned load-bearing part(s) of composite material cover(s) most of the cross-section of the rope.

In one embodiment of the invention the travel height of the elevator is over 30 meters, preferably 30-80 meters, most preferably 40-80 meters, and the elevator is formed to be without compensating rope. Thus the hoisting ropes are so light that the elevator does not need compensating roping. In this case the hoisting rope/hoisting ropes (R) are preferably of the aforementioned composite rope.

In one embodiment of the invention the width of the rope is greater than the thickness in the transverse direction of the rope. Thus the service life of the rope is long, because there is little wear caused by its bending.

In one embodiment of the invention the load-bearing part is a solid elongated rod-like piece.

In one embodiment of the invention the load-bearing part is parallel with the longitudinal direction of the rope.

In one embodiment of the invention the individual reinforcing fibers are homogeneously distributed in the aforementioned matrix.

In one embodiment of the invention the aforementioned reinforcing fibers are continuous fibers in the longitudinal direction of the rope, which preferably continue for the distance of the whole length of the rope.

In one embodiment of the invention the aforementioned reinforcing fibers are bound into a uniform load-bearing part with the aforementioned polymer matrix, preferably in the manufacturing phase by embedding the reinforcing fibers in the material of the polymer matrix.

In one embodiment of the invention the aforementioned load-bearing part comprises straight reinforcing fibers parallel with the longitudinal direction of the rope, which fibers are bound into a uniform part with the polymer matrix.

In one embodiment of the invention essentially all the reinforcing fibers of the aforementioned load-bearing part are in the longitudinal direction of the rope.

In one embodiment of the invention the structure of the load-bearing part continues essentially the same for the whole distance of the rope.

In one embodiment of the invention the polymer matrix is a non-elastomer.

In one embodiment of the invention the module of elasticity (E) of the polymer matrix (M) is over 2 GPa, most preferably over 2.5 GPa, and further preferably in the range 2.5-10 GPa, most preferably of all in the range 2.5-3.5 GPa.

In one embodiment of the invention the polymer matrix comprises epoxy resin, polyester, phenolic plastic or vinyl ester.

In one embodiment of the invention over 50% of the surface area of the cross-section of the load-bearing part is the aforementioned reinforcing fiber, preferably such that 50%-80% is the aforementioned reinforcing fiber, most preferably such that 55%-70% is the aforementioned reinforcing fiber, most preferably such that approx. 60% of the surface area is reinforcing fiber and approx. 40% is matrix material.

In one embodiment of the invention the reinforcing fibers together with the matrix form a uniform load-bearing part, inside which relative abrasive movement among the fibers or between the fibers and the matrix does not essentially occur.

In one embodiment of the invention the width of the load-bearing part is greater than the thickness in the transverse direction of the rope.

In one embodiment of the invention the rope comprises a plurality of the aforementioned load-bearing parts side by side.

In one embodiment of the invention the load-bearing part is surrounded with a polymer layer, which is preferably an elastomer, most preferably a high-friction elastomer such as e.g. polyurethane.

In one embodiment of the invention the load-bearing part is composed of the aforementioned polymer matrix, reinforcing fibers bound to each other by the polymer matrix, and also possibly a coating around the fibers, and possibly also additives mixed into the polymer matrix.

In one embodiment of the invention essentially all the hoisting ropes of the hoisting roping of the elevator are ropes comprising composite materials of the type described above. Thus the hoisting ropes are so light that the elevator does not need compensating roping.

In one embodiment of the invention the aforementioned hoisting rope (R)/hoisting ropes does/do not comprise a metallic load-bearing part. Thus the hoisting rope/hoisting ropes of the elevator R are light.

### LIST OF FIGURES

In the following, the invention will be described in detail by the aid of some embodiments with reference to the attached drawings, wherein

FIG. 1 presents one embodiment of an elevator according to the invention.

FIG. 2 presents diagrammatically a cross-section of one rope, which it is advantageous to use in an elevator according to the invention.

FIG. 3 presents one preferred brake structure for an elevator according to FIG. 1.

FIG. 4 diagrammatically presents a magnified detail of a cross-section of a rope of an elevator according to the invention.

### DETAILED DESCRIPTION OF THE INVENTION

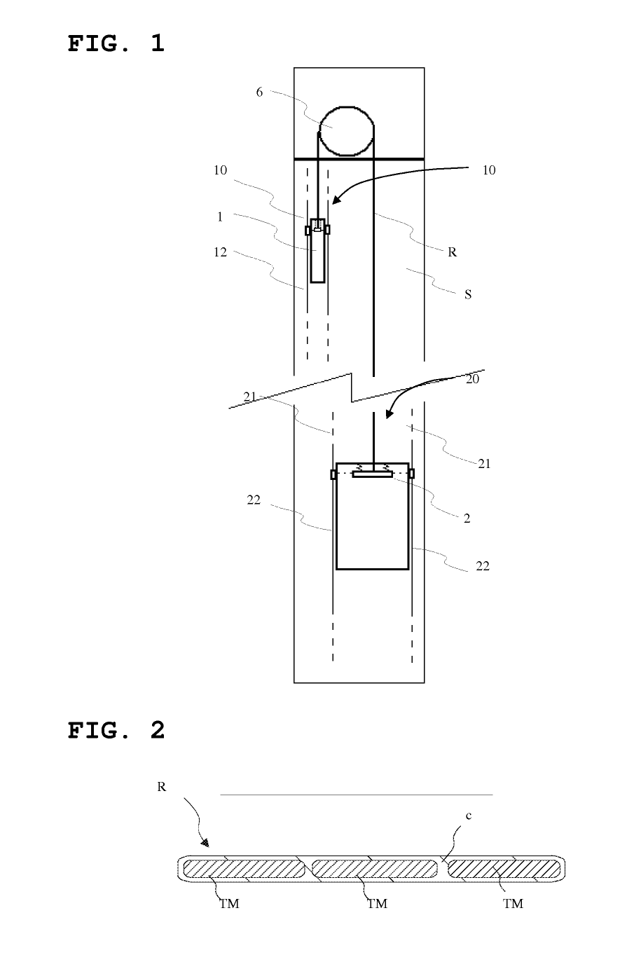

FIG. 1 presents one embodiment of an elevator according to the invention. The elevator comprises an elevator car 2, which is installed to travel in the elevator hoistway S in a building, and at least one hoisting rope R for moving and supporting the elevator car 2, a traction sheave 6 that acts on the hoisting rope R, and a power source (not presented, e.g. an electric motor) for rotating the traction sheave 6. The elevator car and the counterweight each comprise a brake 11,21, by means of which the speed of the elevator car/counterweight in question can be decelerated. The brake corresponds to the guide rails 12,22 of the elevator, and is thus arranged to decelerate the speed of the car/counterweight by taking supporting force needed for deceleration from the guide rails.

The elevator also comprises means 10,20 for starting the braking of the aforementioned brake 11,21. By the aid of these means, the brake comprised in the counterweight is arranged to brake in a situation in which the elevator car suddenly stops or at least slows its speed, and correspondingly the brake comprised in the elevator car is arranged to brake in a situation in which the counterweight suddenly stops or at least slows its speed. Thus continuation of the movement of the elevator car or of the counterweight moving in the opposite direction to the aforementioned elevator car or counterweight after a sudden slowing down of the elevator car or counterweight is prevented or at least considerably reduced.

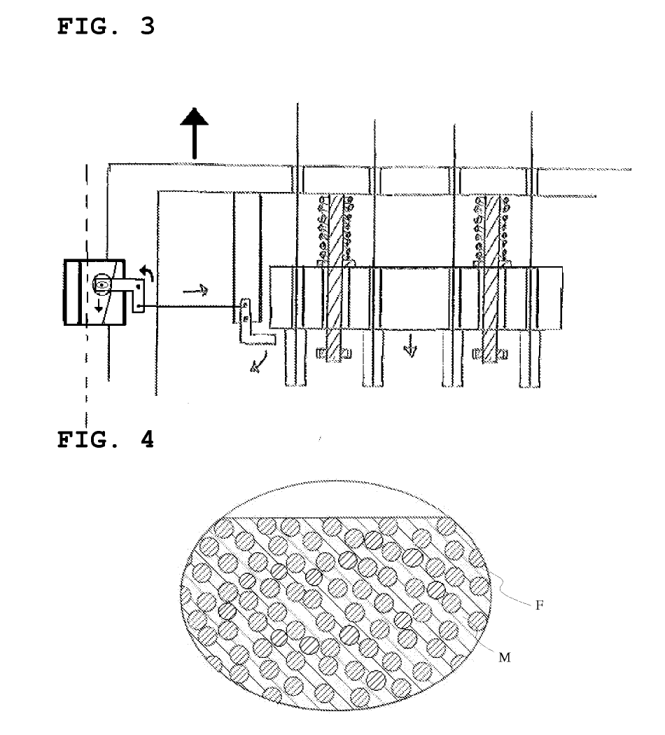

The aforementioned means 10,20 are of the type that with them the braking of the brake comprised in the elevator car and/or of the brake comprised in the counterweight is arranged to start as a consequence of reduced tension of the hoisting ropes. One preferred method to implement these means is presented in FIG. 3.

Preferably the brake 21 comprised in the elevator car 2 is a safety gear corresponding to a guide rail 22 of the elevator car 2 in question, preferably a safety gear which is connected also to the overspeed governor (not presented, e.g. some prior-art one in type) of the elevator, which overspeed governor activates the safety gear after the movement speed of the elevator car has exceeded a certain pre-defined limit value. The safety gear is dimensioned preferably to be such that it is able to stop the elevator car or counterweight in question quickly, the safety gear is preferably arranged after tripping to stop the elevator car or counterweight in question with an acceleration of 2-10 m/s2 when the load of the elevator car is 0-nominal load, preferably also in situations in which the elevator car is moved at normal drive speed, e.g. over 0.5 m/s.

The rope R (or plurality of ropes R) of the elevator presented is preferably a light rope, e.g. essentially the whole load-bearing surface area of which is fiber-reinforced composite. The light rope enables compensating roping to be omitted. A compensating rope is not connected to the counterweight or to the elevator car in the elevator presented, i.e. a rope or corresponding that can pull them downwards with a force that depends on the position of the elevator car/counterweight so that the magnitude of the force increases as the elevator car moves upwards and decreases as the elevator car moves downwards. Neither are the counterweight and the elevator car in the elevator presented connected with a rope or corresponding that passes around a diverting pulley at the bottom end of the elevator hoistway. This type of rope is arranged in an elevator generally with the intent that it exerts on the elevator car and on the counterweight a force pulling it downwards when the aforementioned elevator car or counterweight is moving upwards, by taking supporting force from the aforementioned diverting pulley, and that it prevents or at least essentially reduces the slackening of the hoisting roping in a situation in which the counterweight or the elevator car suddenly stops or at least slows its speed. In that case it is preferable that the counterweight and/or the elevator car comprises a brake, which can stop/decelerate the movement of the counterweight or elevator car in question so that it would not jump, in which case the brake in question performs a so-called lock-down function, or a function corresponding to it, i.e. it functions as an anti-rebound device. The lack of a compensating rope therefore requires other ways to prevent jumping, which in this application is solved with the aforementioned brake 11,21 and with the tripping means 10,20 of the brake.

The arrangement presented, wherein the elevator car and/or the counterweight each comprise a brake, can be used if necessary also as a safety brake in the following situations:
in connection with unintended movement when the car runs away from the door zone with the doors open, and/or
as a terminal slowdown device in the terminal control zone of the hoistway to enhance deceleration during braking in situations in which the approach of a terminal floor according to the speed reference is malfunctioning due to a defect, and/or
as a booster to emergency braking in those elevators in which the dimensioning rule of the “emergency stop” load case according to Annex M of EN81-1 is not fulfilled, which is typical in elevators in which emergency braking is more critical than normal drive in respect of traction sheave friction.

FIG. 2 presents diagrammatically a cross-section of one rope R, which it is advantageous to use in an elevator according to the invention, e.g. in an elevator according to FIG. 1. The rope R is belt-like, i.e. the rope possesses in the first direction, which is at a right angle to the longitudinal direction of the rope, a measured thickness t, and in the other direction, which is the longitudinal direction of the rope and at a right angle to the aforementioned first direction, a measured width w, which width w is essentially greater than the thickness t. The structure of the rope preferably continues essentially the same for the whole distance of the rope, but not necessarily because it is possible, if desired, to arrange for the cross-section to change intermittently, e.g. as toothing. The rope R comprises a load-bearing part TM, which is anon-metallic fiber composite, which load-bearing part comprises carbon fibers or glass fibers, preferably carbon fibers, in a polymer matrix. The load-bearing part TM with fibers is longitudinal to the rope, for which reason the rope retains its structure when bending. Individual fibers are thus oriented in essentially the longitudinal direction of the rope. In this case the fibers are aligned with the force when the rope is pulled. The aforementioned reinforcing fibers are bound into a uniform load-bearing part with the aforementioned polymer matrix. Thus the aforementioned load-bearing part TM is one solid elongated rod-like piece. The aforementioned reinforcing fibers are preferably long continuous fibers in the longitudinal direction of the rope, which preferably continue for the distance of the whole length of the rope. Preferably as many fibers as possible, most preferably essentially all the reinforcing fibers of the aforementioned load-bearing part are in the longitudinal direction of the rope. The reinforcing fibers are thus preferably essentially not intertwined with relation to each other. Thus the structure of the load-bearing part can be made to be the same as far as possible for the whole distance of the rope. The aforementioned reinforcing fibers are distributed in the aforementioned load-bearing part as evenly as possible, so that the load-bearing part would be as homogeneous as possible in the longitudinal direction of the rope. The bending direction of the rope is preferably up or down in the figure. The rope R presented in FIG. 2 comprises a plurality of load-bearing composite parts TM that are rectangular in their cross-sectional shape and that are surrounded with a polymer layer c. Alternatively one load-bearing part TM can form a rope on its own with or without a polymer layer c.

An advantage of the structure presented is that the matrix surrounding the reinforcing fibers keeps the interpositioning of the reinforcing fibers essentially unchanged. It equalizes with its slight elasticity the distribution of a force exerted on the fibers, reduces fiber-fiber contacts and internal wear of the rope, thus improving the service life of the rope. Possible longitudinal movement between the fibers is elastic shearing exerted on the matrix, but in a bend it is mainly a question of the stretching of all the materials of the composite part and not of their movement in relation to each other. The reinforcing fibers are most preferably carbon fiber, in which case good tensile rigidity and a light structure and good thermal properties, among other things, are achieved. Alternatively glass fiber reinforcing fibers, with which among other things better electrical insulation is obtained, are suited to some applications. In this case also the tensile rigidity of the rope is slightly lower, so that traction sheaves of small diameter can be used. The composite matrix, in which the individual fibers are distributed as homogeneously as possible, is most preferably epoxy resin, which has good adhesiveness to the reinforcements and which is strong behaving advantageously with glass fiber and carbon fiber. Alternatively, e.g. polyester or vinyl ester can be used. Most preferably the load-bearing composite part comprises approx. 60% carbon fiber and 40% epoxy resin.

In this application load-bearing part refers to a part of the rope that bears a significant portion of the load in the longitudinal direction of the rope exerted on the rope in question, e.g. of the load exerted on the rope by the elevator car and/or the counterweight supported by the rope. A load causes tension on the load-bearing part in the longitudinal direction of the rope, which tension is transmitted onwards in the longitudinal direction of the rope inside the load-bearing part in question. Thus the load-bearing part can e.g. transmit force exerted on the rope by the traction sheave in the longitudinal direction of the rope to the counterweight and/or to the elevator car in order to move them. For example, in FIG. 1, where the counterweight 2 and the elevator car 3 are suspended on the rope R, more precisely on the load-bearing part TM in at least one (preferably all) of the ropes R of the roping, which load bearing part extends from the elevator car 3 to the counterweight 2. The rope R is fixed to the counterweight and to the elevator car. The tension produced by the counterweight/elevator car is transmitted from the fixing along the load-bearing part of the rope from the counterweight/elevator car upwards at least to the traction sheave 2. The reinforcing fibers of the load-bearing part are preferably essentially all of one and the same material.

FIG. 4 presents a preferred structure for the load-bearing part TM of FIG. 2. A partial cross-section of the surface structure of the load-bearing part (as viewed in the longitudinal direction of the rope) is presented inside the circle in the figure, according to which cross-section the reinforcing fibers of the load-bearing parts presented elsewhere in this application are preferably in a polymer matrix. The figure presents how the reinforcing fibers F are essentially evenly distributed in the polymer matrix M, which is surrounded by fibers and which is fixed to fibers. The polymer matrix M fills the areas between reinforcing fibers F and binds essentially all the reinforcing fibers F that are inside the matrix to each other as a uniform solid substance. In this case abrasive movement between the reinforcing fibers F and abrasive movement between the reinforcing fibers F and the matrix M is essentially prevented. A chemical bond exists between, preferably all, the individual reinforcing fibers F and the matrix M, one advantage, among others, of which is uniformity of the structure. To strengthen the chemical bond, there can be, if needed, but not necessarily, a coating (not presented) between the reinforcing fibers and the polymer matrix M. The polymer matrix M is of the kind described elsewhere in this application and can thus comprise additives for fine-tuning the properties of the matrix as an addition to the base polymer. The polymer matrix M is preferably a hard non-elastomer. The reinforcing fibers being in the polymer matrix in the load-bearing part means here that in the invention the individual reinforcing fibers are bound to each other with a polymer matrix e.g. in the manufacturing phase by embedding them in the material of the polymer matrix. In this case the interspaces of individual fibers bound to each other with the polymer matrix comprise the polymer of the matrix. Thus in the invention preferably a large amount of reinforcing fibers bound to each other in the longitudinal direction of the rope are distributed in the polymer matrix. The reinforcing fibers are preferably distributed essentially evenly, i.e. homogeneously, in the polymer matrix such that the load-bearing part is as homogeneous as possible when viewed in the direction of the cross-section of the rope. In other words the fiber density in the cross-section of the load-bearing part does not therefore vary greatly. The reinforcing fibers together with the matrix form a uniform load-bearing part, inside which relative abrasive movement does not occur when the rope bends. The individual reinforcing fibers of the load-bearing part are mainly surrounded with polymer matrix, but fiber-fiber contacts can occur in places because controlling the position of the fibers in relation to each other in the simultaneous impregnation with polymer matrix is difficult, and on the other hand fully perfect elimination of random fiber-fiber contacts is not wholly necessary from the viewpoint of the functioning of the invention. If, however, it is desired to reduce their random occurrence, the individual reinforcing fibers can be pre-coated such that a polymer coating is around them already before the binding of individual reinforcing fibers to each other. In the invention the individual reinforcing fibers of the load-bearing part can comprise material of the polymer matrix around them such that the polymer matrix is immediately against the reinforcing fiber, but alternatively a thin coating, e.g. a primer arranged on the surface of the reinforcing fiber in the manufacturing phase to improve chemical adhesion to the matrix material, can be in between. Individual reinforcing fibers are distributed evenly in the load-bearing part such that the interspaces of individual reinforcing fibers comprise the polymer of the matrix. Preferably the majority of the interspaces of the individual reinforcing fibers in the load-bearing part are filled with the polymer of the matrix. Most preferably essentially all of the interspaces of the individual reinforcing fibers in the load-bearing part are filled with the polymer of the matrix. The matrix of the load-bearing part is most preferably hard in its material properties. A hard matrix helps to support the reinforcing fibers, especially when the rope bends. When bending, tension is exerted on the reinforcing fibers on the side of the outer surface of the bent rope and compression on the carbon fibers, in the longitudinal direction of them, on the side of the inner surface. The compression endeavors to crumple the reinforcing fibers. When a hard material is selected as the polymer matrix the crumpling of fibers can be avoided because hard material is able to support the fibers and thus to prevent their crumpling and to equalize the tensions inside the rope. To reduce the bending radius of the rope, among other things, it is thus preferred that the polymer matrix is a polymer that is hard, preferably something other than an elastomer (an example of an elastomer: rubber) or something else that behaves elastically or gives way. The most preferred materials are epoxy resin, polyester, phenolic plastic and vinyl ester. The polymer matrix is preferably so hard that its module of elasticity (E) is over 2 GPa, most preferably over 2.5 GPa. In this case the modulus of elasticity (E) is preferably in the range 2.5-10 GPa, most preferably in the range 2.5-3.5 GPa.

FIG. 3 presents one preferred brake structure for an elevator according to FIG. 1 The elevator comprises means 10,20 for initiating braking of the brake 11,21, which brake corresponds e.g. to the guide rails 12,22 of the elevator, in which case it can thus be arranged to decelerate the speed of the car/counterweight by leading the force needed for deceleration from the guide rails. The means 11,21 are of the type that with them the braking of the brake comprised in the elevator car and/or of the brake comprised in the counterweight is arranged to start as a consequence of reduced tension of the hoisting ropes. Thus, by the aid of these means 10,20, the brake comprised in the counterweight can easily be arranged to brake in a situation in which the elevator car suddenly stops or at least slows its speed, and correspondingly the brake comprised in the elevator car is arranged to brake in a situation in which the counterweight suddenly stops or at least slows its speed. Thus continuation of the movement of the elevator car or of the counterweight moving in the opposite direction to the aforementioned elevator car or counterweight after a sudden slowing down of the elevator car or counterweight is prevented or at least considerably reduced. Preferably when the brake 11 is the brake of an elevator car, it is a safety gear corresponding to a guide rail, preferably a safety gear which is connected also to the overspeed governor of the elevator (e.g. to the rope of an overspeed governor).

The means 10,20 comprise a spring 41, which resists the force exerted by the longitudinal tension of the tensioned rope R. The brake is fitted to activate as a consequence of the movement effect resulting from a slackening of the hoisting rope R. More precisely, if the tension of the rope R decreases, the spring force Fs is able to move the part attached to the brake 11,21, most preferably the fixing base (e.g. a hitch plate) 42 (downwards in the figure), and to trip the safety gear via the levers 43,44,45. The lever 43 of the lever mechanism is supported on the elevator car 2 or on the counterweight 1 in a manner that allows bending around the pivot 48 to transmit movement with a lever or with a cable 44 to the lever 45 of the brake, which lever 45 is able from the effect of movement transmitted to it to initiate braking. In the solution presented, the lever 45 rotates around a pivot 47 and pushes the roll 46 between the guide rail 12,22 and the wedge surface of the safety-gear-type brake 11,21. When the lever 45 bends, the end of it moves in relation to the wedge part downwards in the figure and the roll moves simultaneously downwards and to the left in relation to the wedge (supported in the groove in the lever 45 in a manner that allows movement). Continuation upwards of the movement of an upward moving elevator car/counterweight (comprising an arrangement of the figure) wedges the roll even more tightly between the wedge part and the guide rail and stops the elevator. When the rope R slackens owing to a breakage of the ropes or because of jumping (continuation of a movement), in other words when the rope ceases to support the elevator car, the loading of the spring discharges, in which case operating force is released to trip the safety gear, as a result of which the elevator seizes. In the solution presented, the rope R is fixed to its base 42 with a bracket G. The base 42 is able to move in relation to the counterweight 11 or to the elevator car 21 on guide rails 49 in the direction indicated by the arrow, which guide rails however limit the distance moved by the base 42 and movement a certain distance over it. The brake 11,21 is supported on the frame B.

It is obvious to the person skilled in the art that the invention is not limited to the embodiments described above, in which the invention is described using examples, but that many adaptations and different embodiments of the invention are possible within the frameworks of the inventive concept defined by the claims presented below. It is obvious to the person skilled in the art that the invention can be utilized also with ropes of another kind than those presented, e.g. a rope in which there is some other material in place of composite, such as e.g. metal or Aramid braids. It is also obvious that the number of load-bearing parts of the ropes presented can be greater or smaller than what is presented and that the hoisting roping of the elevator can comprise a number of ropes. It is also obvious that the brake does not necessarily need to correspond to the guide rails but instead it could correspond alternatively to e.g. the ropes of the elevator.

1.-18. (canceled)

19. Elevator, preferably a passenger elevator, which comprises an elevator car, and at least one hoisting rope for moving and supporting the elevator car and a counterweight, a traction sheave that acts on the hoisting rope, and a power source for rotating the traction sheave, wherein the counterweight comprises a brake for decelerating and/or preventing at least upward movement of the counterweight.

20. Elevator according to claim 19, wherein the elevator is formed to be without compensating rope.

21. Elevator according to claim 19, wherein the hoisting rope/hoisting ropes, which is/are arranged to move the elevator car and counterweight, comprise only non-metallic load-bearing parts.

22. Elevator according to claim 19, wherein the brake is a jump prevention means and is configured to activate when the elevator car stops quickly and thus to prevent jumping of the counterweight.

23. Elevator according to claim 19, wherein at least the counterweight, and preferably also the elevator car, comprises a brake, which corresponds to a guide rail, under the control of which the counterweight/elevator car in question travels.

24. Elevator according to claim 19, wherein the counterweight and/or the elevator car comprises means, which are arranged to activate the brake comprised in the counterweight and/or the elevator car if the deceleration of the counterweight and/or the elevator car exceeds a certain pre-defined limit value.

25. Elevator according to claim 19, wherein the braking power of the brake is dimensioned so that it does not cause to an empty elevator car in any tripping situation of the brake deceleration greater than a certain pre-defined value, which value is between 3-5 m/s2.

26. Elevator according to claim 19, wherein the braking of the brake comprised in the elevator car and/or of the brake comprised in the counterweight is arranged to start as a consequence of reduced tension of the hoisting ropes, e.g. after the tension of the hoisting rope has decreased to below a certain limit tension.

27. Elevator according to claim 19, wherein the counterweight comprises means, which are arranged to determine the tension of at least one rope supporting the counterweight, and to activate a brake comprised in the counterweight after the tension has fallen below a certain limit tension.

28. Elevator according to claim 19, wherein the elevator car comprises means, which are arranged to determine the tension of at least one rope supporting the elevator car, and to activate a brake comprised in the elevator car after the tension has fallen below a certain limit tension.

29. Elevator according to claim 19, wherein the means comprise a spring, which resists the force exerted by the longitudinal tension of the tensioned rope.

30. Elevator according to claim 19, wherein the brake is fitted to activate as a consequence of the movement effect of the spring resulting from a slackening of the hoisting rope.

31. Elevator according to claim 19, wherein at least the brake comprised in the elevator car is a safety gear corresponding to a guide rail of the elevator car in question, preferably a safety gear which is connected also to the overspeed governor of the elevator, which overspeed governor activates the aforementioned safety gear after the movement speed of the elevator car has exceeded a certain pre-defined limit value.

32. Elevator according to claim 19, wherein the hoisting rope is arranged to move an elevator car and a counterweight, which are preferably suspended on opposite ends of the rope.

33. Elevator according to claim 19, wherein a compensating rope or corresponding is not connected to the counterweight and/or to the elevator car, which compensating rope or corresponding can pull it/them downwards with a force that depends on the vertical position of the elevator car/counterweight in question so that the magnitude of the force increases as the elevator car moves upwards and decreases as the elevator car moves downwards.

34. Elevator according to claim 19, wherein the counterweight and the elevator car are not connected with a rope or corresponding that passes around a diverting pulley at the bottom end of the elevator hoistway.

35. Elevator according to claim 19, wherein the aforementioned hoisting rope comprises at least one, preferably a plurality of, load-bearing parts, which load-bearing part is of composite material, which composite material comprises reinforcing fibers, which are preferably carbon fiber or glass fiber, embedded into a polymer matrix.

36. Elevator according to claim 19, wherein the travel height of the elevator is over 30 meters, preferably 30-80 meters, most preferably 40-80 meters, and in that the elevator is formed to be without compensating rope.

37. Elevator according to claim 20, wherein the hoisting rope/hoisting ropes, which is/are arranged to move the elevator car and counterweight, comprise only non-metallic load-bearing parts.

38. Elevator according to claim 20, wherein the brake is a jump prevention means and is configured to activate when the elevator car stops quickly and thus to prevent jumping of the counterweight.
